(19) United States
(12) Patent Application Publication
(10) Pub. No.: US 2019/0148032 A1
(43) Pub. Date: May 16, 2019

(54) CABLE-WRAPPING TAPE

(71) Applicant: Certoplast Technische Klebebaender GmbH, Wuppertal (DE)

(72) Inventor: Timo LEERMANN, Wuppertal (DE)

(21) Appl. No.: 16/098,961

(22) PCT Filed: Apr. 13, 2017
(86) PCT No.: PCT/EP2017/058898

§ 371 Date: Nov. 5, 2018

(30) Foreign Application Priority Data
May 20, 2016 (DE) 20 2016 102 701.2

(51) Int. Cl. H01B 3/50; D03D 3/00; H01B 3/42; H02G 3/04; C09J 7/21

(52) U.S. Cl. CPC H01B 3/50; D03D 3/005; H01B 3/421; C09J 2203/302; C09J 7/21; D10B 2331/02; H02G 3/0481

(57) ABSTRACT

The subject of the invention is a cable wrapping tape, in particular for wrapping cables in motor vehicles. The cable wrapping tape has a tape-like carrier and an adhesive coating on at least one side of the carrier. The carrier consists of a single woven layer. Moreover, the warp threads and weft threads of the carrier have different finenesses. The weft threads have a fineness of more than 200 dtex, while the weft threads have a fineness of 40 dtex to 100 dtex. According to the invention, the warp threads are formed with a high tensile strength and have a fineness-related highest tensile strength of more than 500 cN/dtex, in particular of more than 8 cN/dtex.

The invention relates to a cable-wrapping tape, particularly for wrapping a cable in an automobile, comprising a substrate strip and an adhesive coating on at least one side of the substrate strip. The substrate strip consists of a single layer of fabric whose warp and weft yarns are of different fineness. The weft yarns have a fineness of greater than 200 dtex and the warp yarns have a fineness of from 40 dtex to 100 dtex.

As is customary, the “warp yarns” in the woven fabric used as the substrate strip are the yarns that extend longitudinally during the weaving process parallel to the selvedge in the finished fabric. Conversely, the “weft yarns” are the cross yarns that are transverse to the longitudinal or warp yarns and hence transverse to the selvedges as well.

In a cable-wrapping tape having the construction described above according to DE 600 31 332 [U.S. Pat. No. 6,790,505], the primary aim is to set the tear strength in the transverse direction to values of less than 10 N/cm so that the known cable-wrapping tape can be easily torn by hand. So-called “manual tearability” is of particular importance for the processing of the cable-wrapping tape when wrapping cables in automobiles, because blades or other cutting devices are otherwise required, for example, and slow the wrapping process.

In order to ensure manual tearability or cross-tearability, and in order to achieve the desired low transverse tearing forces, in the known teaching according to DE 600 31 332 T2 a titer of the longitudinal or warp yarns of between 40 and 60 dtex is used. The titer of the transverse or weft yarns is limited to values of between 150 and 250 dtex. It is true that this results in the total desired manual tearability, and the required low transverse tearing forces are observed. However, this is accompanied by a relatively low abrasion resistance.

Indeed, in addition to the required temperature and media resistance, it is not only the manual tearability described above that plays a special role in such cable-wrapping tapes for wrapping cables in automobiles. Rather, increased abrasion resistance is currently in ever-increasing demand. This can be attributed primarily to the fact that the cables and/or cable harnesses that are sheathed by such cable-wrapping tape undergo tight and compact installation in today's automobiles. This increases the requirements for protection from wear and, consequently, the resistance of the cable wrap to abrading movements and, in particular, abrasion.

To classify the abrasion resistance of cable-wrapping tapes, standards are used that are typically specified by the automotive industry. The most prominent example of this is the standard LV 312-1 “Adhesive tapes for cable harnesses in motor vehicles” (2009) as a common test guideline of the companies Audi, BMW, Daimler Benz, and VW. In fact, in the context of the aforementioned LV 312-1 standard, the abrasion resistance is determined in accordance with DIN ISO 622 such that the adhesive tape to be tested is first glued to a mandrel or metal rod having a diameter of 5 mm. Using a scraper tool with a 0.45 mm needle diameter, the number of strokes required to wear through the adhesive tape is then determined while taking an applied force of 7 N into account. The greater the number of strokes, the more abrasion-resistant the adhesive tape in question.

A distinction is made in practice between abrasion class A, which offers virtually no abrasion protection (number of strokes less than 100), up to class E, which provides high abrasion protection. This corresponds to a stroke count of 5000 and higher before the adhesive tape in question has been worn through in consideration of the abrading test described above.

The abrasion resistance as well as the individual standards are described and presented in detail in other prior art according to EP 1 911 633. Reference is expressly made to this document. The cable-wrapping tape used here is one in which the substrate strip also consists of a single fabric layer and, in addition, a yarn made of polyamide material is used. The individual threads of the yarn have a thread or yarn denier of at least 280 dtex. This is aimed at overall compliance with abrasion class E according to standard LV 312.

It is true that the use of polyamide threads or polyamide yarns within the scope of the known teaching according to EP 1 911 633 increases the protection from wear as desired and increases the abrasion resistance, as is made clear by the abrasion class E that is achieved. However, the cost of producing such a fabric is high, because it relies on costly polyamide yarns. What is more, the yarn thicknesses used in this context of at least 280 dtex in the warp and in the weft have the effect that the known cable-wrapping tape cannot be torn by hand at all, but rather has to be cut to the desired length during the wrapping process, which is time-consuming. This is where the invention comes in.

The object of the invention is to develop further develop a cable-wrapping tape having the construction described above such that the conflicting requirements of abrasion resistance on the one hand and manual tearability on the other hand are satisfied simultaneously.

To attain this object, a cable-wrapping tape of this generic type is characterized in the context of the invention in that the weft yarns have high tensile strength and have a titer-based maximum tensile strength of greater than 5 cN/dtex. That is, the high-tensile-strength design of the weft yarns used corresponds to the fact that their titer-based maximum tensile strength or the so-called tear strength is at values of greater than 5 cN/dtex. The titer-based maximum tensile strength is preferably greater than 8 cN/dtex, and generally reaches values of up to 20 cN/dtex. The measurement of the maximum tensile strength is carried out in this context according to the specifications in DIN EN ISO 2062.

That is, the titer-based tenacity is 0.05 N/dtex or 0.08 N/dtex to about 0.2 N/dtex. From this, it follows that, with a thread or yarn thickness of each weft yarn of 1 dtex, the weft yarn in question has a maximum tensile strength of 5 cN or 0.05 N at minimum. Since the weft yarns used in the context of the invention usually have a thread or yarn thickness (titer) of at least 200 dtex, it follows that each individual weft yarn is provided with a maximum tensile strength of greater than 10 N (0.05 N×200).

In this context, if it is additionally taken into account that the number of weft yarns in the fabric of the backing is preferably in the range from 10/cm to 30/cm, this results in a width-based rupture strength in the weft direction of 100 N/cm to 300 N/cm and greater. After all, even greater tensile strengths can be achieved, namely when working with weft yarns having a titer of greater than 200 dtex.

In fact, the titer of the weft yarns can be more than 250 dtex. In particular, a value of 280 dtex and preferably of 350 dtex and greater is observed for the titer of the weft yarns. Very especially preferably, the weft yarns can be provided with a titer of more than 400 dtex, and more preferably 470 dtex and greater. In addition, it has proven expedient overall in this connection to limit the titer of each weft yarn to a maximum of 700 dtex. Of course, this is not restrictive.

In any case, the weft yarns have a high tear strength; what is more, a width-based tear strength of at least 100 N/cm is observed in the weft direction of the fabric for the substrate strip of the cable-wrapping tape according to the invention, with values of 300 N/cm and much more being typically observed. In this way, the “thick” weft yarns contribute to ensuring and determining the abrasion resistance required by the cable-wrapping tape according to the invention. In fact, abrasion resistance of at least abrasion class C is observed here, particularly on a 5 mm diameter mandrel according to the previously mentioned LV 312-1 standard (2009).

This increased abrasion resistance of at least abrasion class C is achieved by the cable-wrapping tape according to the invention while maintaining manual tearability. This can essentially be attributed to the fact that, unlike the weft yarns, the warp yarns have a titer-based maximum tensile strength of 3.5 cN/dtex at maximum. Moreover, the titer of the warp yarns is in the range of from 40 dtex to 100 dtex.

Assuming a titer-based maximum tensile strength of 3.5 cN/dtex, corresponding to 0.035 N/dtex, the maximum tensile strength that can be achieved with such a warp yarn is calculated to be from as low as 1.4 N (0.035 N/dtex×40 dtex) to 3.5 N (0.035 N/dtex×100 dtex). This maximum tensile strength of the warp yarns is substantially less than that of the weft yarns. According to an advantageous embodiment, if the number of warp yarns in the fabric of the substrate strip is in the range of 15 to 60/cm, this results in a length-based maximum tensile strength of from 21 N/cm to 210 N/cm.

In principle, even values of less than 21 N/cm can be observed and set because the calculation of this value was based on the upper limit for the titer-based maximum tensile strength of the respective warp yarn of 3.5 cN/dtex. For example, if a titer-based maximum tensile strength of 2 cN/dtex at maximum for each warp yarn is taken as the basis and, moreover, a titer of the warp yarn of 40 dtex with 15 yarns/cm in the fabric of the substrate strip is determined, the maximum tensile strength for each warp yarn is calculated at only 0.8 N. Assuming 15 warp yarns/cm in the fabric of the substrate strip, this results in a length-based maximum tensile strength of only 12 N/cm. Such values must be considered to be manually tearable in the transverse direction, because the warp yarns are stretched practically until the maximum tensile strength has been exceeded during such hand tearing in the transverse direction, so the warp yarns tear as desired.

Ideally, the weft yarns—optionally in conjunction with the adhesive coating—primarily ensure in this context that the warp yarns are not shifted against one another during the tearing operation and, in fact, that the previously indicated values for the maximum tensile strengths are observed. These can then be identified with the appropriate forces or transverse tearing forces, as they were also investigated in the context of the prior art according to DE 600 31 332 T2.

In any case, transverse tearing forces of routinely less than 20 N/cm and consequently also corresponding length-based maximum tensile strengths for the warp yarns of less than 20 N/cm are considered in the context of the invention to (still) be manually tearable. Consequently, for the first time, the cable-wrapping tape according to the invention combines the required manual tearability for easy processing when wrapping cables in automobiles on the one hand with the required abrasion resistance in the installed state on the other hand. After all, the values for the abrasion class C that is achieved are typically sufficient here. Herein lie the fundamental advantages.

The warp yarns and the weft yarns in the single fabric layer of the substrate strip can be plastic yarns of different materials. That is, it is conceivable in principle for polyester yarns to be used here as warp yarns and polyamide yarns as weft yarns, for example. As a rule, however, the warp yarns and the weft yarns are plastic yarns of the same material. In this case, the described high-tensile weft yarns with the required titer-based maximum tensile strength of greater than 5 cN/dtex on the one hand and, as it were, standard polyester yarns as warp yarns on the other hand are used. This is because, as warp yarns, such standard polyester yarns can typically make do with a maximum strength of less than 3.5 cN/dtex at maximum.

The fact that the weft yarns are designed to be substantially “thicker” than the warp yarns—namely with a titer in the range of from 200 dtex to a maximum of 700 dtex—whereas the warp yarns are provided with a titer in the range of from 40 dtex to 100 dtex also explains how abrasion class C can be achieved as a minimum. This is observed when applying the previously mentioned LV 312-1 standard to a mandrel with a 5 mm diameter and adjusts itself.

The substrate strip consisting of the single fabric layer is generally provided with a thickness of no more than 0.5 mm. The thickness is usually in the range of from 0.2 mm to 0.5 mm. In addition, the substrate strip in question that is constructed from the single layer of fabric typically has a weight per unit area in the range from 100 g/m² to 250 g/m². As stated above, the number of weft yarns in the fabric of the substrate strip ranges from 10/cm to 30/cm. The number of warp yarns, on the other hand, can be slightly higher. In fact, a number of warp yarns in the range of 15/cm to 60/cm will be used here in the fabric of the substrate strip.

One adhesive coating that can be recommended as being suitable is based on a pressure-sensitive adhesive that, overall, provides a self-sticking adhesive coating. In this context, acrylate adhesives have typically proven to be especially favorable, with those that are UV cross linkable being especially favorable here. The pressure-sensitive adhesive or the adhesive coating in question is generally applied to the substrate strip at a specific weight per unit area in the range of from 50 g/m² to 200 g/m².

The high abrasion resistance can be attributed first and foremost to the high-tensile weft yarns used. After all, the weft yarns are provided with a titer of greater than 200 dtex on the one hand and with a titer-based maximum tensile strength of greater than 5 cN/dtex on the other hand. In this way, the cable-wrapping tape according to the invention can already be designed to be especially resistant to abrasion even if standard polyester yarns are used as warp yarns. In order to make available the high-tensile weft yarns or polyester yarns in question, they are generally drawn and heat-set. Consequently, a pronounced parallel orientation of the individual polyester linear molecules is observed. The parallel orientation can reach values of 90% and more. Moreover, degrees of crystallinity of up to 80% are observed. All of this has the effect that abrasion resistance of at least abrasion class C is observed and, at the same time, the cable-wrapping tape according to the invention can be torn by hand nevertheless.

Moreover, the use of different polyester yarns in warp and weft ensures that the cable-wrapping tape is also media and temperature resistant, and it can be easily dyed and coated with the adhesive. It is also readily possible to apply an additional coating to the opposite side of the adhesive coating or to use a smoothed substrate strip. All of this is achieved in consideration of minimized manufacturing costs compared to the prior art. Herein lie the fundamental advantages.

1. In a cable-wrapping tape for wrapping cables in automobiles comprising a substrate strip and an adhesive coating on at least one side of the substrate strip, the improvement wherein:
the substrate strip consists of a single layer of fabric, the warp yarns and the weft yarns of the substrate strip are of different titer,
the weft yarns have a titer of greater than 200 dtex, and
the warp yarns have a titer of from 40 dtex to 100 dtex, characterized in that
the weft yarns have a titer-based maximum tensile strength of greater than 5 cN/dtex.

2. The cable-wrapping tape according to claim 1, wherein the warp yarns have a titer-based maximum tensile strength of at most 3.5 cN/dtex.

3. The cable-wrapping tape according to claim 1, wherein the weft yarns have a titer of greater than 250 dtex.

4. The cable-wrapping tape according to claim 1, wherein the weft yarns have a titer of no more than 700 dtex.

5. The cable-wrapping tape according to claim 1, wherein the warp yarns and weft yarns are plastic yarns of different materials.

6. The cable-wrapping tape according to claim 1, wherein the warp yarns and weft yarns are plastic yarns of the same material.

7. The cable-wrapping tape according to claim 1, wherein each plastic yarn is composed of more than 20 filaments.

8. The cable-wrapping tape according to claim 7, wherein each yarn consists of more than 24 filaments.

9. The cable-wrapping tape according to claim 7, wherein each yarn is composed of fewer than 100 filaments.

10. The cable-wrapping tape according to claim 1, wherein at least abrasion class C is achieved on a mandrel with a diameter of 5 mm.

11. The cable-wrapping tape according to claim 1, wherein the substrate strip has a thickness of no more than 0.5 mm.

12. The cable-wrapping tape according to claim 1, wherein the substrate strip has a weight per unit area of from 100 g/m² to 250 g/m².

13. The cable-wrapping tape according to claim 1, wherein the number of warp yarns in the fabric of the substrate strip lies in a density range from 15/cm to 60/cm.

14. The cable-wrapping tape according to claim 1, wherein the number of weft yarns in the fabric of the substrate strip lies in a density range from 10/cm to 30/cm.

15. The cable wrapping tape according to claim 6 wherein the warp and weft yarns are of polyester.
